(19) United States
(12) Patent Application Publication
(10) Pub. No.: US 2006/0256215 A1
(43) Pub. Date: Nov. 16, 2006

(54) System and method for subtracting dark noise from an image using an estimated dark noise scale factor

(76) Inventors: Xuemei Zhang, Mountain View, CA (US); Richard L. Baer, Los Altos, CA (US); Dietrich Werner Vook, Los Altos, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/129,831

(22) Filed: May 16, 2005

(51) Int. Cl. H04N 9/64

(52) U.S. Cl. 348/243

(57) ABSTRACT

An image processing system subtracts dark noise out of images based on a dark noise scale factor. The image processing system includes an image sensor for capturing a current image and producing current image data representing the current image. The current image data includes both a dark noise signal and an image signal. The dark noise scale factor for the current image is estimated from the current image data and reference image data representing a reference dark noise signal. The reference dark noise signal is scaled by the dark noise scale factor to produce a scaled dark noise signal from which the current image data is subtracted to produce the image signal.

### BACKGROUND OF THE INVENTION

Electronic image sensors are predominantly of two types: CCD (Charge Coupled Devices) and CMOS-APS (Complementary Metal Oxide Semiconductor—Active Pixel Sensors). Both types of sensors typically contain an array of photo-detectors, arranged in a pattern, that generate electrical charge in response to light. Each photo-detector corresponds to a pixel of an image and measures the intensity of light of the pixel within one or ranges of wavelengths, corresponding to one or more perceived colors.

However, despite advances in the manufacturing process, both CCD and CMOS image sensors often contain defects that produce undesirable noise in the image. For example, one significant source of noise in an image is known as “dark current noise.” Dark current noise is a fixed pattern noise that results from manufacturing defects in the photo-detectors. The defects cause the photo-detectors to accumulate charge even in the absence of light. Typically, the dark current in an image sensor creates an undesirable “dark” image that overlays the illuminated image.

Since the spatial pattern of dark current noise on a particular image sensor is mostly constant (based on the pattern of photo-detector defects), which generates a noise pattern with a fixed element and a smaller random element, image sensors have traditionally employed a dark current subtraction mechanism to remove the effects of dark current in an image. For example, in cameras that utilize a shutter, a dark image (dark frame) with the shutter closed can be obtained along with the illuminated image (image frame) with the shutter open. The dark frame is subtracted from the image frame to yield an image frame without most of the dark noise component.

Another example of a dark current subtraction process is described in U.S. Pat. No. 6,714,241 to Baer, entitled “Efficient Dark Current Subtraction in an Image Sensor,” (hereinafter referred to as the Baer patent). In the Baer patent, a dark noise image is stored on the image sensor and subtracted from each new image captured. However, the level of dark noise in a particular image is a function of both the image sensor temperature and the exposure time of the particular image. Therefore, to effectively remove the dark noise in a particular image, the stored dark noise image must be scaled for the temperature and exposure time. The Baer patent uses a few rows of “black pixels” on the image sensor to accomplish the dark noise scaling. Each black pixel is covered by a metal layer so that the sensor values of the black pixels represent only dark noise. By comparing the mean or clipped mean of the sensor values of the black pixels to the mean of the stored dark noise image, the appropriate scale factor for a particular image can be estimated.

The dark current subtraction process described in the Baer patent not only provides dark noise image correction in cameras without shutters, but also enhances the frame rate of cameras with shutters. However, the Baer dark current subtraction process does require several rows of pixels to be reserved as “black pixels,” which may not be desirable in many applications. As a result, if a camera without a shutter does not use an image sensor with black pixels, there is currently no dark current subtraction process available to remove the effects of dark current in the image.

### SUMMARY OF THE INVENTION

Embodiments of the present invention provide an image processing system for subtracting dark noise out of images without requiring the use of “black pixels.” The image processing system includes an image sensor, a memory and a processor. The image sensor captures a current image and produces current image data representing the current image. The current image data includes both a current dark noise signal and an image signal. The memory stores reference image data representative of a reference dark noise signal produced by the image sensor. The processor estimates a dark noise scale factor from the current image data and the reference image data, scales the reference dark noise signal by the dark noise scale factor to produce a scaled dark noise signal and subtracts the scaled dark noise signal from the current image data to produce the image signal.

In one embodiment, the processor uses a linear regression algorithm to calculate the dark noise scale factor. The linear regression algorithm determines regression coefficients representing the linear relations between the current image data and the reference image data. The dark noise scale factor is calculated from the regression coefficients. For example, the regression coefficients can identify a slope value and an intercept value representing the linear relationship between the current image data and the reference image data.

In a further embodiment, the image sensor includes an array of pixels arranged in rows and columns. The processor uses respective selected raw sensor values of the reference image data and the current image data generated by corresponding selected pixels in the array to estimate the dark noise scale factor. In one aspect of the invention, the selected pixels include a portion of the pixels corresponding to a dark region of the current image. In another aspect of the invention, the selected pixels are randomly selected. In still another aspect of the invention, the selected pixels are selected to uniformly sample noise level pixel values of the reference dark noise signal. In a further aspect of the invention, the selected pixels include at least one row of pixels that produces a noise level distribution in the reference dark noise signal nearest a uniform noise level distribution in the reference dark noise signal.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating an image processing system for subtracting dark noise from an image, in accordance with embodiments of the present invention;

FIG. 2 is a logic flow diagram illustrating exemplary logic for subtracting dark noise from an image using an estimated dark noise scale factor, in accordance with embodiments of the present invention;

FIG. 3 illustrates an image sensor for subtracting dark noise from an image, in accordance with embodiments of the present invention;

FIG. 4 is a flowchart illustrating an exemplary process for subtracting dark noise from an image using an estimated dark noise scale factor, in accordance with embodiments of the present invention;

FIGS. 5A and 5B are charts illustrating mean and standard deviations of estimated dark noise scale factors for one example with a particular level of dark noise as a function of the number of sampled pixels;

FIG. 6 is a flowchart illustrating an exemplary process for subtracting dark noise from an image using a dark noise scale factor estimated from dark regions of the image, in accordance with embodiments of the present invention; and

FIGS. 7A and 7B are charts illustrating mean and standard deviations of estimated dark noise scale factors estimated from dark regions of an image for one example with a particular level of dark noise as a function of the number of sampled pixels.

### DETAILED DESCRIPTION OF EXEMPLARY EMBODIMENTS

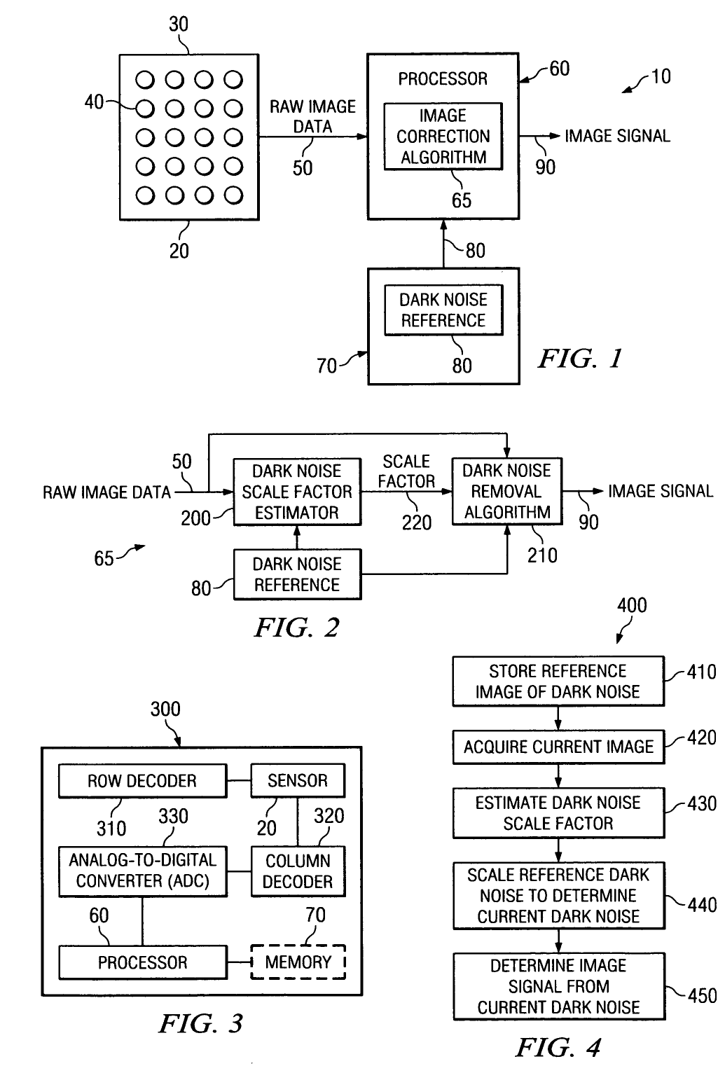

FIG. 1 is a block diagram illustrating an image processing system 10 for subtracting dark noise from an image, in accordance with embodiments of the present invention. The image processing system 10 can be incorporated as part of any digital imaging device, such as a camera, video camera, medical imaging device, etc. The image processing system 10 can further be at least partially incorporated on a computer system, such as a personal computer, web server or other type of computing device.

The image processing system 10 includes an image sensor 20, a processor 60 capable of executing a dark noise subtraction algorithm 65 and a memory 70 for storing dark noise reference image data 80. The image sensor 20 is part of a CMOS sensor chip or a CCD sensor chip, and includes a two-dimensional array of photo-detectors 40 arranged in rows and columns. Each photo-detector 40 generates a sensor value corresponding to a pixel of an image. The image sensor 20 provides raw image data 50 containing the raw sensor (pixel) values to the processor 60.

The processor 60 accesses the memory 70 to retrieve the reference image data 80, and uses the reference image data 80 while executing the dark noise subtraction algorithm 65 to remove the effects of dark current in the raw image data 50. The processor 60 can be a microprocessor, microcontroller, programmable logic device or any other processing device. In one embodiment, the processor 60 is built into the sensor chip incorporating the image sensor 20. In another embodiment, the processor 60 is part of a computing system that can be connected to the image sensor 20 via a wired or wireless interface. The memory 70 can be any type of memory device, such as a flash ROM, EEPROM, ROM, RAM or any other type of storage device. In another embodiment, the memory 70 further stores the dark noise subtraction algorithm 65 executable by the processor 60.

The dark noise subtraction algorithm 65 estimates a dark noise scale factor for the current image from the raw image data 50 and the stored reference image data 80 using any appropriate statistical process. The raw image data 50 includes both an image signal representing the image and a dark noise signal representing a dark noise component. The stored reference image data 80 includes a reference dark noise signal that represents a reference image captured by the image sensor 20 without illumination. The reference image data 80 can be stored at any time prior to generating the raw image data 50 for the current image. For example, the reference image data 80 can be generated and stored during manufacturing of the image sensor 20 or at any time subsequent to the manufacture of the image sensor 20.

The dark noise subtraction algorithm 65 scales the reference image data 80 by the estimated scale factor to produce scaled reference image data. The dark noise subtraction algorithm further subtracts the scaled reference image data from the raw image data 50 to subtract out the dark noise signal in the raw image data 50, thereby producing the desired image signal 90 without a significant part of the dark noise component.

Referring now to FIG. 2, exemplary logic for implementing the dark noise subtraction algorithm 65 is illustrated. The dark noise subtraction algorithm 65 includes dark noise scale factor estimation logic 200 and dark noise remover logic 210. As used herein, the term “logic” includes any hardware, software and/or firmware for performing the logic functions.

The dark noise scale factor estimation logic 200 takes as input the raw image data 50 provided by the image sensor 20 and the reference image data 80, estimates the scale factor 220 for the current image from the raw image data 50 and the reference image data 80 and outputs the scale factor 220 for the current image. The dark noise scale factor estimation logic 200 uses any appropriate statistical process to estimate the scale factor 220.

For example, in one embodiment, the dark noise scale factor estimation logic 200 applies a linear regression process to the raw image data 50 and the reference image data 80 to determine the linear relationship between the raw image data 50 and the reference image data 80. The linear regression process determines linear regression coefficients of best-fitting linear functions that relate the raw image data 50 to the reference image data 80. More specifically, the linear regression coefficients represent the slope and intercept between the raw image data 50 and the reference image data 80. The dark noise scale factor estimation logic 200 calculates the estimated scale factor 220 from the slope using linear prediction.

As an example, if xⱼ represents the stored reference image data 80, and yⱼ represents the sensor value of a captured image at pixel location j, which has a signal level of sⱼ if no dark noise were present, the expected sensor values E[yⱼ] can be represented as:
E[yⱼ]=sⱼ+E[nⱼ]+k*E[xⱼ], (Equation 1)
where k is the dark noise scale factor for the particular captured image, nⱼ represents noise components other than dark noise (e.g., read noise and shott noise), and E[x] represents the expected value of a random variable x. Since the dark noise is independent of the particular image being captured and other noise contributors, the image signal term sⱼ and the non-dark noise term nⱼ are independent of the dark noise term k*xⱼ. As a result, the dark noise scale factor k can be estimated by a linear regression method, using the stored reference dark noise values E[xⱼ] as the predictor and the image signal values yⱼ as the data for all sampled j.

Using Equation (1) above, the dark noise scale factor k can be calculated by:
T=(X^{t}X)⁻¹X^{t}Y, (Equation 2)
where Y is a vector with sensor values yⱼ at all sampled pixel locations, and X is a two-column matrix with the stored reference dark noise values xⱼ at corresponding sampled pixel locations (corresponding to the sensor value yⱼ pixel locations) in the first column and ones (1) in the second column. The column with ones is used to allow for an offset term in the regression solution, since the signal term sⱼ has a positive expected value. The estimated scale factor k is the first element (i.e., the slope coefficient) in the solution T.

The dark noise scale factor estimation logic 200 provides the estimated scale factor 220 to the dark noise remover logic 210 for use in removing the dark noise in the raw image data 50. Thus, the dark noise remover logic 210 takes as input the raw image data 50, the estimated scale factor 220 and the reference image data 80. The dark noise remover logic 210 scales the reference image data 80 by multiplying the estimated scale factor 220 by each of the reference dark noise values in the reference image data 80. The resulting scaled reference image data is subtracted from the raw image data 50 on a pixel-by-pixel basis to produce the image signal 90.

For example, if the reference image data is represented by sensor values xⱼ and the raw image data is represented by sensor values yⱼ, where j represents a particular pixel location (photo-detector) in the image sensor, the scaled reference image data (SDⱼ) can be represented as:
SDⱼ=k*xⱼ, (Equation 3)
and therefore, the image signal (Iⱼ) is calculated as:
Iⱼ=yⱼ−(k*xⱼ) (Equation 4)

In one embodiment, the dark noise scale factor estimation logic 200 and the dark noise remover logic 210 of the dark noise subtraction algorithm 65 are implemented on a computing system remote from the digital imaging device (e.g., camera) including the image sensor. For example, the dark noise subtraction algorithm 65 can be incorporated on a personal computer or computing device (e.g., photo-finisher station or photo printer). As another example, the dark noise subtraction algorithm 65 can be incorporated on a web server, and the raw image data 50 can be uploaded to the web server for dark noise removal. In another embodiment, the dark noise scale factor estimation logic 200 and dark noise remover logic 210 are implemented on a separate chip from the sensor chip in the imaging device. In still another embodiment, the dark noise scale factor estimation logic 200 and dark noise remover logic 210 are implemented on the sensor chip incorporating the image sensor.

Referring now to FIG. 3, an exemplary sensor chip 300 incorporating the dark noise subtraction algorithm is illustrated. The sensor chip 300 includes the image sensor 20 having a photo-detector array for capturing an image projected thereon and for generating an analog signal representative thereof. A row decoder 310 and column decoder 320 select the rows and columns of the photo-detector array for reading the analog signal representing the pixel values and resetting the photo-detectors. The analog signal is converted to a corresponding digital image signal by an analog-to-digital converter (ADC) 320. For example, the ADC 320 can be a six-bit, eight-bit or ten-bit ADC 320.

The digital image signal containing the raw image data (i.e., raw sensor (pixel) values) is input to the processor 60, which accesses the memory 70 to retrieve the reference dark noise signal. The memory 70 can be included on the sensor chip 300 or on a separate chip. The processor 60 uses the stored reference dark noise signal to subtract out the dark noise in the digital image signal.

FIG. 4 is a flowchart illustrating an exemplary process 400 for subtracting dark noise from an image using an estimated dark noise scale factor, in accordance with embodiments of the present invention. Initially, at block 410, a reference dark noise image is captured by an image sensor and sensor values representing the reference dark noise are stored. The reference dark noise image is captured with no light illuminating the image sensor, and therefore, the sensor values representing the reference dark noise image include predominantly the dark noise, though it may include other sources of random noise. The random element of the dark noise and other noises in the reference image can be reduced by averaging several frames of the reference image captured in dark. At block 420, a current image is acquired by the image sensor. The current image includes both an image signal representing the desired image and a noise component.

At block 430, a dark noise scale factor is estimated from the current image and the stored reference dark noise image, and at block 440, the reference dark noise image is scaled by the estimated scale factor to determine a scaled reference dark noise image representing the current dark noise in the current image. Since the level of dark noise in the current image is a function of the image sensor temperature at the time of image capture and the exposure time of the current image, the sensor values representing the current image can be used to determine the scale factor for scaling the stored reference dark noise image to the appropriate level for the temperature and exposure time of the current image. Once the dark noise in the current image is ascertained, at block 450, the dark noise is subtracted from the current image to produce an image without the fixed element of dark noise.

Although the sensor values for each pixel location in the current image and the reference image can be used to estimate the scale factor, the scale factor can also be estimated using a subset of the sensor values at sampled pixel locations, with minimal increase in estimation error. Reducing the number of pixels utilized to estimate the scale factor reduces the computational load on the image sensor and/or computing device. For example, the scale factor can be estimated with as few as one-hundred corresponding pixels from each image (current and reference). The sampled pixels can be randomly selected or selected based on the pixel values.

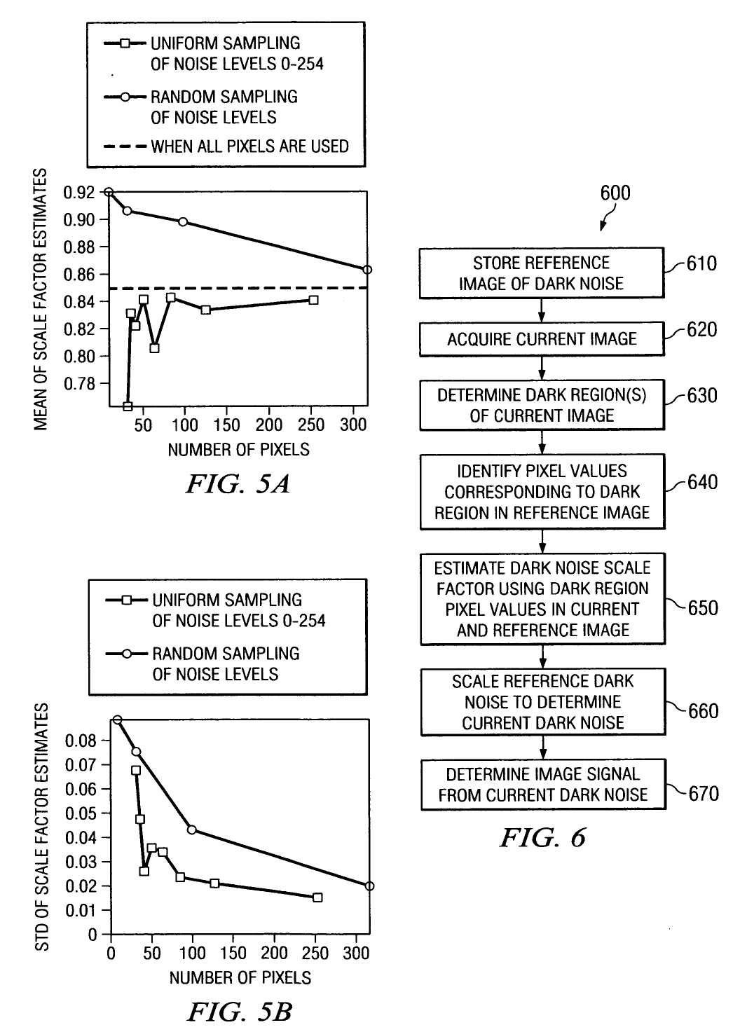

FIGS. 5A and 5B are charts illustrating mean and standard deviations of estimated dark noise scale factors as a function of the number of sampled pixels for one example. As can be seen in FIG. 5A, the scale factor estimated using the whole image (all of the sensor values in both the current and reference images) is 0.85. When image pixels are randomly selected to estimate the scale factor, as the number of image pixels used for estimation increases towards three-hundred pixels, the estimated value of the scale factor approaches the 0.85 level, and the standard deviation of the estimated scale factor decreases. However, when image pixels are selected to uniformly sample noise level pixel values of the reference dark noise image, the estimated value of the scale factor approaches the correct level right around one-hundred pixels.

Dark noise distributions tend to concentrate on smaller noise levels, with few pixels having large noise values. Therefore, a random sample of pixel locations of the reference dark noise image will yield primarily low pixel values. Such a randomly sampled distribution is not desirable when using a linear regression method to estimate the slope. Therefore, by uniformly sampling pixel locations with an equal number of pixels at each noise level in the reference dark noise image, the scale factor estimates stabilize significantly faster as compared to random sampling.

In an exemplary embodiment, to minimize the storage space necessary for identifying the uniformly sampled pixels to be used in the scale factor estimation process, the pixel values in each row of the reference dark noise image can be searched to determine at least one row of pixels that producing a noise level distribution nearest the uniform noise level distribution in the reference dark noise signal. As a result, instead of storing the pixel locations of each uniformly sample pixel, only the row number(s) identifying the rows to be used in the scale factor estimation process need to be stored.

In another embodiment, the sampled pixels used to estimate the scale factor can be selected based on the pixel values in the current image. Darker regions of an image produce sensor values with lower signal levels and thus proportionally higher dark noise levels (i.e., lower signal-to-noise ratio). Thus, by using the sensor values in the dark regions of an image, the linear relationship between the dark noise in the current image and the stored dark noise can be more accurately determined. For example, the sampled pixel locations can be selected by doing an initial de-noising (e.g., median filtering) on the current image, and then selecting the pixel locations with pixel values (after de-noising) below a pre-set threshold (e.g., a digital value of 10 out of 255). As another example, the pixel locations can be divided into regions (or rows), and the selected pixels in the current image include the regions (or rows) with the most number of pixel locations having pixel values below the pre-set threshold or with an average pixel value below an average pre-set threshold.

FIG. 6 is a flowchart illustrating an exemplary process 600 for subtracting dark noise from an image using a dark noise scale factor estimated from dark regions of the image, in accordance with embodiments of the present invention. Initially, at block 610, a reference dark noise image is captured by an image sensor and sensor values representing the reference dark noise are stored. At block 620, a current image is acquired by the image sensor. The current image includes both an image signal representing the desired image and a noise component. At block 630, sampled pixel values in pixel locations corresponding to dark regions of the current image are determined (e.g., a region or row with primarily low pixel values), and at block 640, sampled pixel values in the corresponding pixel locations of the reference dark noise image are identified.

At block 650, a dark noise scale factor is estimated from the sampled pixel values of the current and reference image, and at block 660, the reference dark noise image is scaled by the estimated scale factor to determine a scaled reference dark noise image representing the current dark noise in the current image. Thereafter, at block 670, the dark noise is subtracted from the current image to produce an image without the fixed element of dark noise.

FIGS. 7A and 7B are charts illustrating mean and standard deviations of estimated dark noise scale factors estimated from dark regions of an image as a function of the number of sampled pixels. Again, in FIG. 7A, the scale factor estimated using the whole image (all of the sensor values in both the current and reference images) is 0.85, and random selection of pixels converges to 0.85 at approximately three-hundred pixels. By selecting pixels for use in estimating the scale factor corresponding to a dark region of the current image, the scale factor estimates converges to 0.85 starting at one-hundred pixels with lower standard deviations.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. An image processing system, comprising:
an image sensor operable to capture a current image and produce current image data representing said current image, said current image data including a current dark noise signal and an image signal;
a memory for storing reference image data representative of a reference dark noise signal produced by said image sensor; and
a processor operable to estimate a dark noise scale factor from said current image data and said reference image data, to scale said reference dark noise signal by said dark noise scale factor to produce a scaled dark noise signal and to subtract said scaled dark noise signal from said current image data to produce said image signal.

2. The system of claim 1, wherein said processor is further operable to determine regression coefficients representing the linear relations between said current image data and said reference image data and to calculate said dark noise scale factor using said regression coefficients.

3. The system of claim 2, wherein said regression coefficients comprise a slope value representing the linear relationship between said current image data and said reference image data.

4. The system of claim 1, wherein said image sensor includes an array of pixels, arranged in rows and columns.

5. The system of claim 4, wherein said reference image data and said current image data each include respective selected raw sensor values generated by corresponding selected ones of said pixels in said array, and wherein said processor uses said selected raw sensor values of said current image data and said reference image data to estimate said dark noise scale factor.

6. The system of claim 5, wherein said selected pixels producing said selected raw sensor values of said reference image data and said current image data include a portion of said pixels corresponding to a dark region of said current image.

7. The system of claim 5, wherein said selected pixels producing said selected raw sensor values of said reference image data and said current image data are randomly selected.

8. The system of claim 5, wherein said selected pixels producing said selected raw sensor values of said reference image data and said current image data are selected to uniformly sample noise level pixel values of said reference dark noise signal.

9. The system of claim 8, wherein said selected pixels include at least one row of said pixels producing a noise level distribution in said reference dark noise signal nearest a uniform noise level distribution in said reference dark noise signal.

10. The system of claim 5, wherein said selected pixels include at least one-hundred of said pixels within said array.

11. An image sensor, comprising:
an array of pixels arranged in rows and columns, said pixels being operable to capture a current image and produce current image data representing said current image, said current image data including a current dark noise signal and an image signal; and
a processor operable to receive reference image data representative of a reference dark noise signal produced by ones of said pixels, to estimate a dark noise scale factor from said current image data and said reference image data, to scale said reference dark noise signal by said dark noise scale factor to produce a scaled dark noise signal and to subtract said scaled dark noise signal from said current image data to produce said image signal

12. The sensor of claim 11, wherein said reference image data and said current image data each include respective selected raw sensor values generated by corresponding selected ones of said pixels in said array, and wherein said processor uses said selected raw sensor values of said current image data and said reference image data to estimate said dark noise scale factor.

13. The sensor of claim 12, wherein said selected pixels producing said selected raw sensor values of said reference image data and said current image data include a portion of said pixels corresponding to a dark region of said current image.

14. The sensor of claim 12, wherein said selected pixels producing said selected raw sensor values of said reference image data and said current image data are randomly selected.

15. The sensor of claim 12, wherein said selected pixels producing said selected raw sensor values of said reference image data and said current image data are selected to uniformly sample noise level pixel values of said reference dark noise signal.

16. The sensor of claim 15, wherein said selected pixels include at least one row of said pixels producing a noise level distribution in said reference dark noise signal nearest a uniform noise level distribution in said reference dark noise signal.

17. The sensor of claim 12, further comprising a memory for storing at least said selected raw sensor values of said reference image data.

18. A method for subtracting dark noise from an image, comprising:
providing reference image data representative of a reference dark noise signal;
acquiring current image data including a current dark noise signal and an image signal;
estimating a dark noise scale factor from said current image data and said reference image data;
scaling said reference dark noise signal by said dark noise scale factor to produce a scaled dark noise signal; and
subtracting said scaled dark noise signal from said current image data to produce said image signal.

19. The method of claim 18, wherein said estimating said dark noise scale factor includes:
determining regression coefficients representing the linear relations between said current image data and said reference image data; and
calculating said dark noise scale factor using said regression coefficients.

20. The method of claim 18, wherein said estimating said dark noise scale factor includes:
estimating said dark noise scale factor using selected ones of raw sensor values of said current image data and corresponding selected ones of raw sensor values of said reference image data.

21. The method of claim 20, further comprising:
selecting said selected raw sensor values to correspond to a dark region of a current image represented by said current image data.

22. The method of claim 20, further comprising:
randomly selecting said selected raw sensor values.

23. The method of claim 20, further comprising:
selecting said selected raw sensor values to uniformly sample noise levels of said reference dark noise signal.
